(19) United States
(12) Patent Application Publication
(10) Pub. No.: US 2026/0058541 A1
(43) Pub. Date: Feb. 26, 2026

(54) ELECTRONIC CONTROL UNIT

(71) Applicant: DENSO CORPORATION, Kariya-city (JP)

(72) Inventor: KEI SANADA, Kariya-city (JP)

(21) Appl. No.: 19/254,280

(22) Filed: Jun. 30, 2025

(30) Foreign Application Priority Data
Aug. 26, 2024 (JP) 2024-144450

(51) Int. Cl. H02M 1/14; H02M 1/32; H02M 3/158

(52) U.S. Cl. CPC H02M 1/14; H02M 1/32; H02M 3/1584

(57) ABSTRACT

An electronic control unit includes a multiphase power supply, a detector, and a load. The multiphase power supply includes inductors. The detector detects a short circuit between the inductors based on an output voltage of the multiphase power supply. The load operates with the output voltage. The detector includes a first comparator, an integrator and a second comparator. The first comparator performs comparison between a predetermined first threshold and a ripple component of the output voltage. The integrator performs counting of a result of the comparison performed by the first comparator. The second comparator performs comparison between a predetermined second threshold and an output of the integrator. The detector outputs a predetermined signal, on a condition that the output of the integrator exceeds the predetermined second threshold.

### CROSS REFERENCE TO RELATED APPLICATION

This application is based on Japanese Patent Application No. 2024-144450 filed on Aug. 26, 2024, the disclosure of which is incorporated herein by reference.

### TECHNICAL FIELD

The present disclosure relates to an electronic control unit.

### BACKGROUND

An electronic device may detect a ripple voltage and determine whether the ripple voltage is greater than a threshold value.

### SUMMARY

The present disclosure describes an electronic control unit that includes a multi-phase power supply, a detector, and a load.

### BRIEF DESCRIPTION OF DRAWINGS

FIG. 1 is a diagram illustrating an electronic control unit according to a first embodiment;

FIG. 2 is a circuit diagram illustrating a multiphase power supply;

FIG. 3 is a perspective view illustrating a coupled inductor;

FIG. 4 is a perspective view illustrating a core;

FIG. 5 is a perspective view illustrating a coil;

FIG. 6 is a diagram illustrating an example of a short between inductors;

FIG. 7 is a diagram illustrating the PWM waveforms of each phase and the Vout1 waveform;

FIG. 8 is a block diagram illustrating the detection unit;

FIG. 9 is a timing chart illustrating various signal waveforms;

FIG. 10 is a flowchart illustrating the process executed by the detection unit;

FIG. 11 is a block diagram illustrating the detection unit in the electronic control unit according to a second embodiment; and

FIG. 12 is a flowchart illustrating the process executed by the detection unit.

### DETAILED DESCRIPTION

When a comparative electronic device is adapted to a configuration including a multi-phase power supply with multiple inductors and a load that is operated by receiving the output voltage of the multi-phase power supply, it may not be possible to distinguish whether a ripple voltage is high due to a short circuit between the inductors or due to fluctuations in the load. From the above-mentioned perspective, or from other perspectives not mentioned, further improvements may be required for the electronic control unit.

According to an aspect of the present disclosure, an electronic control unit includes a multiphase power supply, a detector, and a load. The multiphase power supply includes inductors. The detector detects a short circuit between the inductors based on an output voltage of the multiphase power supply. The load operates with the output voltage. The detector includes a first comparator, an integrator and a second comparator. The first comparator performs comparison between a predetermined first threshold and a ripple component of the output voltage. The integrator performs counting of a result of the comparison performed by the first comparator. The second comparator performs comparison between a predetermined second threshold and an output of the integrator. The detector outputs a predetermined signal, on a condition that the output of the integrator exceeds the predetermined second threshold.

According to the electronic control unit described above, it is possible to detect that an increase in the ripple component of the output voltage is occurring continuously (steadily). Therefore, it is possible to detect a short circuit between the inductors included in the multi-phase power supply.

The various embodiments disclosed in this specification employ different technical means to achieve their respective objectives. The reference numerals in parentheses described in the present disclosure are intended to exemplify the correspondence with parts of the embodiments described later and are not intended to limit the technical scope. The objects, features, and advantages disclosed in this specification will become more apparent from the following detailed description and the accompanying drawings.

Hereinafter, multiple embodiments will be described with reference to the drawings. The same or corresponding elements are designated with the same reference numerals throughout the embodiments, and descriptions thereof will not be repeated. When only part of the configuration is described in each embodiment, the configuration of the other preceding embodiments can be applied to other parts of the configuration. Further, not only the combinations of the configurations explicitly shown in the description of the respective embodiments, but also the configurations of the multiple embodiments can be partially combined even when they are not explicitly shown as long as there is no difficulty in the combination in particular.

### First Embodiment

An electronic control unit according to the present embodiment is applicable to, for example, a mobile body. The mobile body includes vehicles such as engine-driven vehicles, hybrid vehicles, and motor-driven vehicles, as well as aircraft such as drones and eVTOLs, and also includes ships, construction machinery, and agricultural machinery. eVTOL stands for electronic Vertical Take-Off and Landing aircraft. For example, when applied to a vehicle, the electronic control unit controls the equipment installed in the vehicle. The electronic control unit may also be referred to as an ECU.

The electronic control unit may, for example, execute control related to the movement of a mobile body, or it may execute control unrelated to the movement of the mobile body. The electronic control unit may be, for example, an autonomous driving ECU or an ADAS ECU that executes control to assist the driving operations of the driver. ADAS stands for Advanced Driving Assistance System. For example, as defined by the Society of Automotive Engineers (SAE International), Levels 3 to 5 correspond to autonomous driving levels, while Levels 1 to 2 correspond to driver assistance levels. The electronic control unit may also be an infotainment ECU or a cockpit ECU. The cockpit ECU controls devices such as the meter cluster, navigation system, and air conditioning system.

### (Electronic Control Unit)

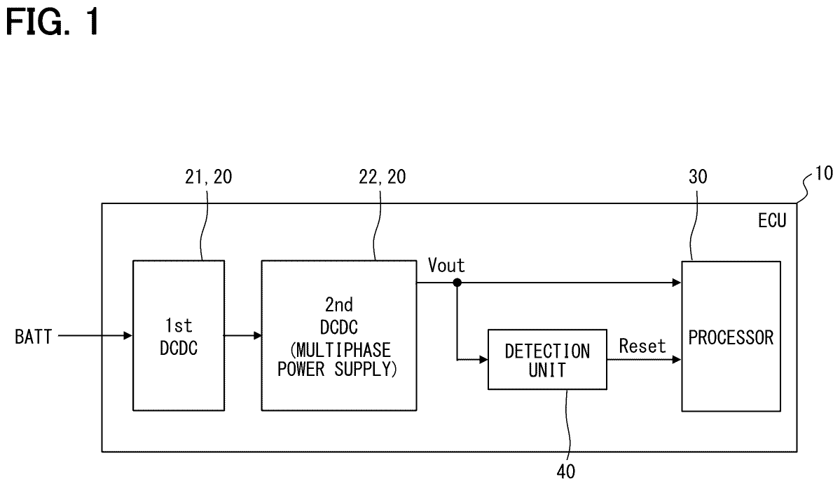

FIG. 1 illustrates an example of an electronic control unit according to the present embodiment. The electronic control unit (ECU) 10 includes a power supply circuit 20, a processor 30, and a detection unit 40. The detection unit 40 may also be referred to as a detector. The power supply circuit 20 includes at least a multi-phase power supply. The exemplary electronic control unit (ECU) 10 is mounted on a vehicle. The power supply circuit 20 includes a primary power supply circuit 21 and a secondary power supply circuit 22. The secondary power supply circuit 22 is a multi-phase power supply. Hereinafter, the secondary power supply circuit 22 may be referred to as the multi-phase power supply 22. As will be described later, the multi-phase power supply 22 includes multiple inductors 24.

The primary power supply circuit 21 and the secondary power supply circuit 22 are configured to step down the input voltage to a predetermined voltage and output the predetermined voltage. The primary power supply circuit 21 and the secondary power supply circuit 22 are step-down type DC-DC converters. For example, the primary power supply circuit 21 generates a constant voltage lower than the power supply voltage (for instance, 5 V) based on the power supplied from a battery installed in the vehicle. The secondary power supply circuit 22 generates a constant voltage lower than the voltage generated by the primary power supply circuit 21 (for instance, around 1 V) based on the output of the primary power supply circuit 21.

The processor 30 is an example of a load that operates by receiving power supplied from the power supply circuit 20 (secondary power supply circuit 22). The processor 30 is, for example, a CPU or GPU. CPU stands for Central Processing Unit. GPU stands for Graphics Processing Unit. The electronic control unit 10 may be equipped with a single processor 30 or multiple processors. The electronic control unit 10 may be equipped with multiple types of processors 30. The processor 30 executes a control program stored in a memory (not shown) to perform predetermined processing for control. The memory is a non-transitory tangible storage medium that non-transitorily stores programs, data, and the like, which are readable by a computer.

The core voltage of the processor 30 is around 1 V (for example, less than 1 V), and the load current is several tens of amperes or more (for example, 100 A or more). To accommodate such low voltage and high current requirements, the electronic control unit 10 employs a multiphase power supply 22 as its power circuit 20. The multiphase power supply 22 steps down the input voltage to a voltage corresponding to the core voltage of the processor 30 and outputs it. By using the multiphase power supply 22, it can accommodate the enhanced performance of the processor 30 associated with improvements in autonomous driving levels and the evolution of infotainment functions, particularly supporting autonomous driving levels 3 and above.

The detection unit 40 detects a short circuit occurring between the inductors that are included in the multiphase power supply 22. The detection unit 40 detects a short circuit occurring between different inductors 24 based on the output voltage Vout of the multiphase power supply 22. Details of the detection unit 40 will be described later.

### (Multiphase Power Supply)

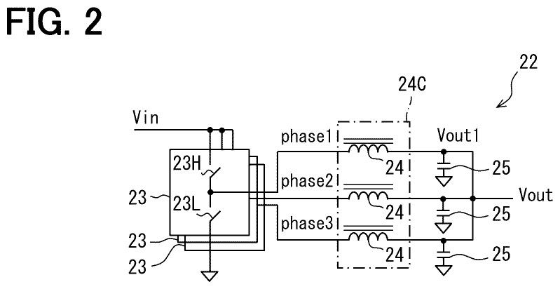

FIG. 2 is a circuit diagram illustrating a multiphase power supply (secondary power circuit). For convenience, some drivers are simplified in FIG. 2. The multiphase power supply 22 includes multiple drivers 23, multiple inductors 24 provided corresponding to the drivers 23, and a capacitor 25. The multiphase power supply 22 has multiple phases. Phases are sometimes referred to as stages or channels.

The driver 23 includes switching elements 23H and 23L, respectively. The switching elements 23H and 23L may be, for example, MOSFETs or IGBTs. The switching elements 23H and 23L may also be bipolar transistors. MOSFET stands for Metal Oxide Semiconductor Field Effect Transistor. IGBT stands for Insulated Gate Bipolar Transistor. The switching elements 23H and 23L are connected in series between the power supply line, where the input voltage Vin is applied, and the ground (GND) line, with the switching element 23H positioned on the high-side. The input voltage Vin is the output of the primary power supply circuit 21.

One end of the inductor 24 is connected to the connection point (midpoint) of the switching elements 23H and 23L. The other end of the inductor 24 is connected to the output line. The inductor 24 is provided separately for the driver 23. The drivers 23 and inductors 24 of respective phases are connected in parallel with each other. By parallelization, the output current from the multi-phase power supply 22, that is, the load current, can be increased. The number of phases is not particularly limited. The exemplary multi-phase power supply 22 has three phases.

The capacitor 25 is connected to the output line. The positive terminal of the capacitor 25 is connected to the output line. The negative terminal of the capacitor 25 is connected to ground. The capacitor 25 may be provided individually for each phase, or it may be provided commonly for multiple phases. In the exemplary multi-phase power supply 22, the capacitor 25 is provided for each phase.

The electronic control unit 10 may include a power supply control unit (not shown). The multi-phase power supply 22 may include a power supply control unit. The power supply control unit may, for example, perform voltage mode control based on the feedback of the output voltage Vout and control the operation of the driver 23, that is, the operation of the switching elements 23H and 23L. The power supply control unit determines the pulse width (duty cycle) of the PWM signal based on the output voltage Vout and controls the output voltage Vout of the multi-phase power supply 22. The power supply control unit may perform current mode control instead of voltage mode control.

The power supply control unit synchronously controls the multiple drivers 23 such that the multiple drivers 23 perform switching operations at different phases from each other. By using multiple phases in this manner, it is possible to pseudo-increase the switching frequency even if the switching frequencies of the multiple drivers 23 are the same. This allows for the reduction of ripple components in the output voltage and improvement in responsiveness, among other benefits. The power supply control unit switches the number of drivers 23 performing the switching operation, i.e., the number of driving phases, according to the load current. The power supply control unit compares the load current with a threshold current and increases and/or decreases the number of driving phases based on the comparison result.

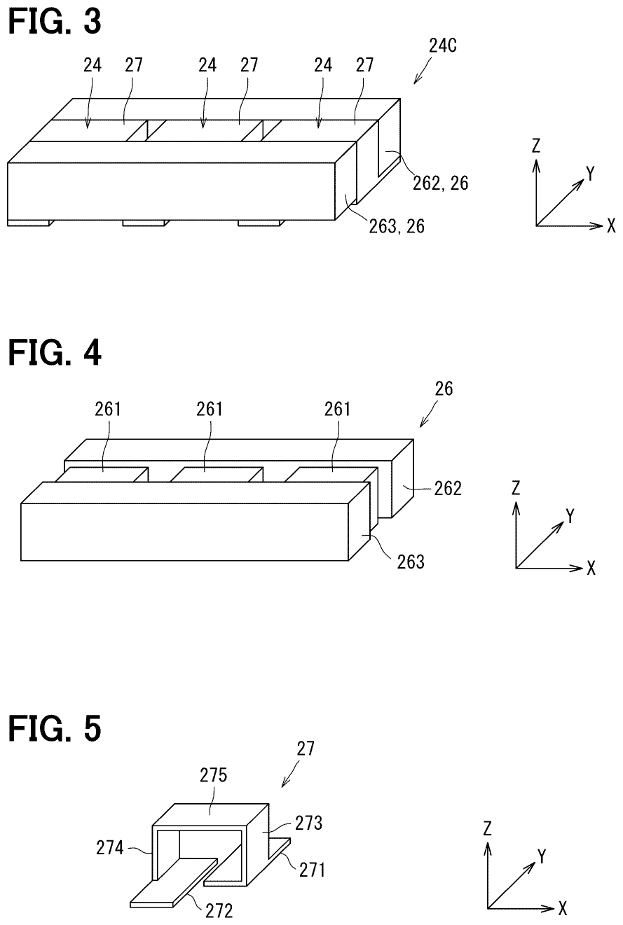

The multi-phase power supply 22 may be configured to include multiple individually provided inductors 24. The multi-phase power supply 22 may be configured to include an inductor component in which multiple inductors 24 are packaged together. The exemplary multi-phase power supply 22 is configured to include a coupled inductor 24C. FIG. 3 is a perspective view illustrating an example of a coupled inductor. FIG. 4 is a perspective view illustrating a core. FIG. 5 is a perspective view illustrating a coil.

In the following, the alignment direction of the multiple coils is indicated as the X direction. A direction orthogonal to the X direction and indicating the alignment direction of the two end cores is referred to as the Y direction. A direction orthogonal to both the X direction and the Y direction is referred to as the Z direction. Unless otherwise specified, the shape viewed in plan from the Z direction, in other words, the shape along the XY plane defined by the X direction and the Y direction, is referred to as the planar shape. The plan view from the Z direction may simply be referred to as the plan view.

A single coupled inductor 24C provides multiple inductors 24 that are included in the multi-phase power supply 22. As shown in FIGS. 3 to 5, the coupled inductor 24C includes a core 26 and multiple coils 27. The coils 27 are arranged on a single core 26, that is, on a common core 26, and are magnetically coupled to each other. By using the coupled inductor 24C, the magnetic flux between phases can cancel each other out, thereby reducing the effective inductance.

The core 26 is formed using a magnetic material such as ferrite. The core 26 functions as a magnetic circuit. The core 26 has multiple central cores 261, and end cores 262 and 263. The core 26 may be formed by a single member or may be formed by combining multiple members. The core 26 has the coil 27 inserted through it. The central core 261 is provided individually for the coil 27. The coil 27 is wound around the central core 261. The central core 261 extends in the Y direction. Multiple central cores 261 are aligned in the X direction with a predetermined spacing. The exemplary core 26 has three central cores 261. Each central core 261 is approximately rectangular in shape. The three central cores 261 have the same shape as each other.

The end cores 262 and 263 are arranged opposite to each other in the Y direction. The end cores 262 and 263 have the central cores 261 positioned between them. The end cores 262 and 263 extend in the X direction, which is the alignment direction of the multiple central cores 261. One end of each of the multiple central cores 261 is connected to the end core 262, while the other end of each of the multiple central cores 261 is connected to the end core 263. The end cores 262 and 263 magnetically connect the multiple central cores 261. The exemplary end cores 262 and 263 have the same shape as each other. The end cores 262 and 263 are in the shape of a substantially rectangular parallelepiped, with the X direction as the longitudinal direction.

The coil 27 is formed using a metal material with better conductivity, such as copper. The coil 27 is formed by processing a metal plate material, rather than using a metal wire material. The metal plate material is sometimes referred to as a metal frame. The multiple coils 27 are formed using the same material and have the same shape. The multiple coils 27 have approximately equal inductance. The multiple coils 27 are aligned in the X direction with a predetermined spacing between them. The multiple coils 27 are aligned in the same orientation. The coils 27 are fixed to the core 26, for example by adhesive bonding. By positioning adjacent coils 27 closer together, the flux cancellation effect can be enhanced. In other words, the effect of reducing the effective inductance can be enhanced.

The coils 27 are formed by bending a metal plate material with a predetermined thickness. The coils 27 (coupled inductor 24C) are mounted on a substrate (not shown). The coils 27 each have terminal portions 271 and 272, side wall portions 273 and 274, and an upper wall portion 275. The terminal portions 271 and 272 are external connection terminals in the coil 27. The plate thickness directions of the terminal portions 271 and 272 are approximately parallel to the Z direction. The terminal portions 271 and 272 extend in the Y direction. The exemplary terminal portions 271 and 272 have a substantially rectangular planar shape with the Y direction as the longitudinal direction. The terminal portions 271 and 272 are arranged side by side in the X direction with a predetermined interval between them. A part of the side surface of terminal portion 271 and a part of the side surface of terminal portion 272 face each other in the X direction.

The side wall portion 273 is connected to the part of terminal portion 271 that faces terminal portion 272. The side wall portion 273 is bent at an angle of approximately 90 degrees relative to the terminal portion 271. The thickness direction of the side wall portion 273 is approximately parallel to the X direction. The side wall portion 273 has a width equal to the length of the facing portions of terminal portions 271 and 272, and extends in the Z direction. Similarly, the side wall portion 274 is connected to the part of terminal portion 272 that faces terminal portion 271. The side wall portion 274 is bent at an angle of approximately 90 degrees relative to the terminal portion 272. The thickness direction of the side wall portion 274 is approximately parallel to the X direction. The side wall portion 274 has a width equal to the length of the facing portions of terminal portions 271 and 272, and extends in the Z direction, which is the same direction as the side wall portion 273. The lower ends of the side wall portions 273 and 274 are connected to the terminal portions 271 and 272.

The upper wall portion 275 bridges the side wall portions 273 and 274. The upper wall portion 275 extends in the X direction. One end of the upper wall portion 275 is connected to the upper end of the side wall portion 273, and the other end is connected to the upper end of the side wall portion 274. The upper wall portion 275 has the same width as the side wall portions 273 and 274.

The opposing sections of the terminal portions 271 and 272, the side wall portions 273 and 274, and the upper wall portion 275 surround the core portion 261. The opposing sections of the terminal portions 271 and 272, the side wall portions 273 and 274, and the upper wall portion 275 are mounted on and wound around the core portion 261. In the extended portions, excluding the opposing sections of the terminal portions 271 and 272, end cores 262 and 263 are positioned.

### (Inductor Short-Circuit and Ripple Variation)

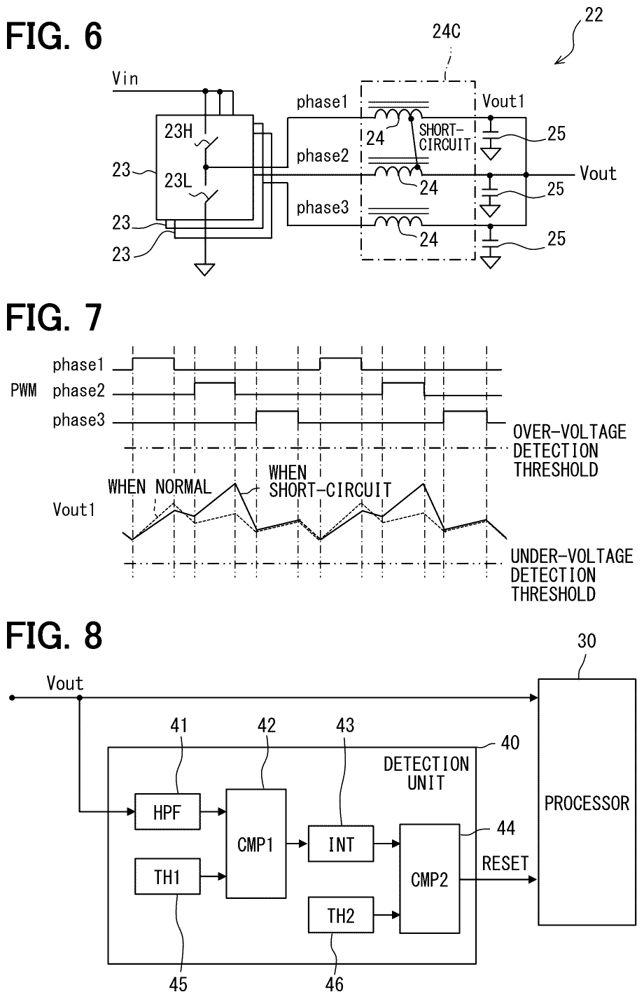

FIG. 6 is a diagram illustrating an example of a short circuit between inductors. In a configuration having multiple inductors 24, such as a configuration where multiple inductors 24 are arranged in a predetermined direction, there is a risk of a short circuit occurring between adjacent inductors due to the intrusion of conductive foreign matter, migration, and the like. Particularly when using a coupled inductor 24C, bringing adjacent coils 27 closer together, as mentioned above, makes it more likely for a short circuit to occur between the neighboring inductors.

In FIG. 6, a short circuit has occurred between the inductor 24 of phase 1 and the inductor 24 of phase 2 among the three phases. Vout1 shown in FIG. 6 is the output voltage of phase 1.

FIG. 7 is a diagram illustrating the PWM waveforms of each phase and the Vout1 waveform. In FIG. 7, the on-period with a predetermined duty ratio is simplified for illustration. The PWM waveform indicates the on-period and the off-period. FIG. 7 shows the waveforms in the case where coupled inductors are used. Among the output voltage Vout1 waveforms, the dashed line indicates the waveform under normal conditions, and the solid line indicates the waveform during a short circuit. The solid line indicates the waveform when a short circuit occurs between the inductors of phase 1 and phase 2, as shown in FIG. 6. The two-dot chain line for the output voltage Vout1 indicates the overvoltage detection threshold and the undervoltage detection threshold.

Under normal conditions, the output voltage Vout1 significantly rises during the on-period of phase 1. Due to the influence of magnetic coupling, the output voltage Vout1 also rises during the on-periods of phase 2 and phase 3. The rise in output voltage Vout1 during the on-periods of phase 2 and phase 3 is smaller than the rise during the on-period of phase 1.

When a short circuit occurs between the inductors, the output voltage Vout1 significantly rises during the on-periods of phase 1 and phase 2. Due to the influence of magnetic coupling, the output voltage Vout1 also rises during the on-period of phase 3. The rise in output voltage Vout1 during the on-period of phase 3 is smaller than the rise during the on-periods of phase 1 and phase 2. Due to the short circuit between the inductors, the ripple variation approximately doubles, but it rarely reaches the overvoltage detection threshold. In other words, the overvoltage detection threshold and undervoltage detection threshold commonly used in fault diagnosis cannot detect a short circuit between the inductors.

### (Detection Unit)

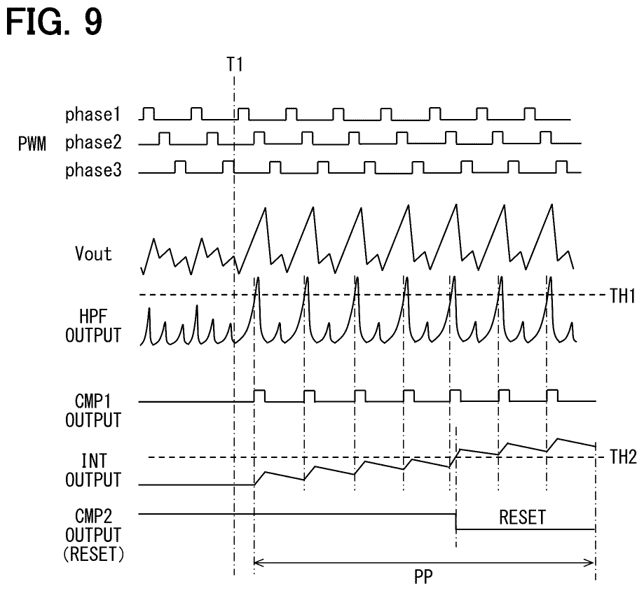

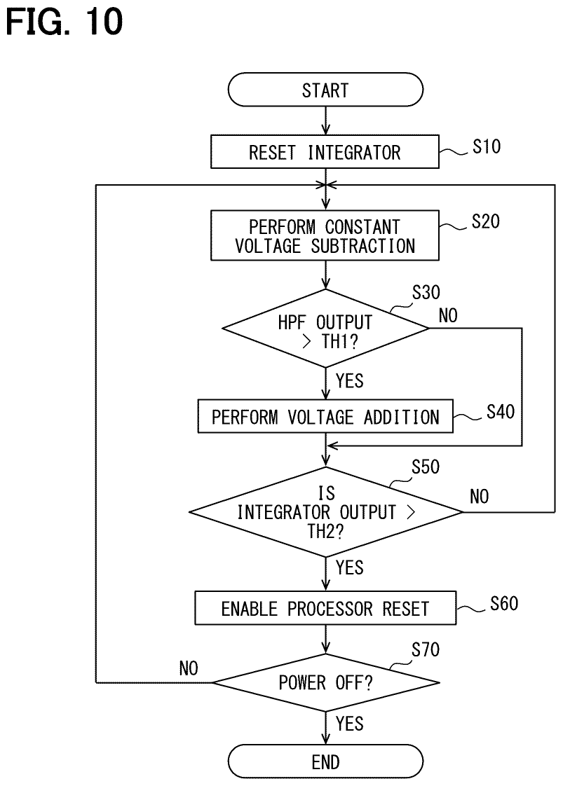

FIG. 8 is a block diagram showing the detection unit. FIG. 9 is a timing chart showing various signal waveforms. FIG. 10 is a flowchart illustrating the process executed by the detection unit.

As mentioned above, the detection unit 40 detects a short circuit between inductors of the multi-phase power supply 22. At least a portion of the functions of the detection unit 40 may be implemented in hardware, and at least a portion of the functions may be implemented in software. The detection unit 40 may include, for example, analog circuits or digital circuits. The detection unit 40 includes a high-pass filter (HPF) 41, a comparator (CMP1) 42, an integrator (INT) 43, and a comparator (CMP2) 44.

The high-pass filter 41 is a filter that allows signals with frequencies higher than a predetermined frequency (cutoff frequency) to pass through. The high-pass filter 41 allows the ripple component, which is the AC component of the output voltage Vout of the multi-phase power supply 22, to pass through. The ripple component is sometimes referred to as ripple voltage.

The comparator 42 compares the ripple component with a threshold (TH1) 45 and outputs the result of the comparison. The comparator 42 determines whether the ripple component is increasing or not. The integrator 43 counts the comparison results from the comparator 42. The integrator 43 counts when the ripple component exceeds the threshold 45. The integrator 43 detects whether the increase in the ripple component is occurring continuously or not. The comparator 44 compares the output of the integrator 43 with the threshold (TH2) 46 and outputs the comparison result. The comparator 44 determines whether a short circuit between inductors has occurred based on the output of the integrator 43.

The detection unit 40 outputs a predetermined signal when the output of the integrator 43 exceeds the threshold 46. The detection unit 40 outputs a signal based on the comparison result from the comparator 44. In the exemplary detection unit 40, the comparison result from the comparator 44 is output to the processor 30. The comparator 44 outputs a signal to the processor 30 to reset the processor 30 when the output of the integrator 43 exceeds the threshold 46. The comparator 44 activates the output signal, which is the Reset signal, to reset the processor 30. In other words, it enables the reset of the processor 30.

FIG. 9 is a timing chart illustrating an example of various signal waveforms. FIG. 9 shows the PWM waveforms of each phase, the Vout waveform, the output waveform of the high-pass filter (HPC) 41, the output waveform of the comparator (CMP1) 42, the output waveform of the integrator (INT) 43, and the output waveform of the comparator (CMP2) 44. In FIG. 9, as in FIG. 7, the on-period with a predetermined duty ratio is simplified for illustration. Additionally, the Vout waveform is simplified for illustration. In FIG. 9, TH1 indicates threshold 45 (threshold voltage), and TH2 indicates threshold 46 (threshold voltage).

FIG. 9 shows the waveforms when a short circuit occurs between the inductor 24 of phase 1 and the inductor 24 of phase 2 at timing T1, similar to FIG. 6. When a short circuit occurs between the inductors of phase 1 and phase 2 at timing T1, current flows through the inductors 24 of both phase 1 and phase 2 during the on-period of phase 1. Additionally, during the on-period of phase 2, current flows through the inductors 24 of both phase 1 and phase 2. Therefore, the fluctuation of Vout becomes larger after timing T1.

As a result, the fluctuation in the output of the high-pass filter (HPF) 41 after timing T1, that is, the fluctuation of the ripple component, also becomes larger. Therefore, the output voltage of the high-pass filter 41 periodically exceeds the threshold (TH1) 46 after timing T1. The output voltage of the high-pass filter 41 exceeds the threshold (TH1) 46 during the on-periods of both phase 1 and phase 2.

The comparator (CMP1) 42 outputs an H-level signal indicating an increase in the ripple component when the output voltage of the high-pass filter 41 exceeds the threshold (TH1) 46. The comparator 42 outputs an L-level signal when the output voltage of the high-pass filter 41 is below the threshold 46. The comparator 42 periodically outputs an H-level signal after timing T1.

The integrator (INT) 43 counts the number of H-level signals output from the comparator 42. The integrator 43 adds voltage when an H-level signal is output from the comparator 42. After adding the voltage, the voltage decreases due to discharge until the next voltage addition. After timing T1, since H-level signals are periodically output from the comparator 42, the output of the integrator 43 increases with each count. When the H-level output from the comparator 42 continues for a predetermined number of times consecutively, the output of the integrator 43 exceeds the threshold (TH2) 46.

The threshold 46 is set to a value that is greater than the output voltage of the integrator 43 when the number of H-level signals output from the comparator 42 is less than the predetermined number of times, and smaller than the output of the integrator 43 when the number of H-level signals output from the comparator 42 is equal to or greater than the predetermined number of times. The predetermined number of times is set to be greater than the number of times the ripple component exceeds the threshold 45 under the maximum fluctuation conditions of the processor 30. The maximum fluctuation conditions refer to the fluctuation conditions under which the ripple component variation is at its maximum among the load fluctuations.

The comparator (CMP2) 44 outputs a Reset signal to the processor 30. The comparator 44 outputs an L-level signal, which is a signal for resetting the processor 30, when the output of the integrator 43 exceeds the threshold (TH2) 46. The comparator 44 outputs an H-level signal when the output of the integrator 43 is below the threshold 46. The comparator 44 activates the Reset signal, that is, the comparator 44 switches from H-level to L-level, when the output of the integrator 43 exceeds the threshold 46. In this manner, when the output of the integrator 43 exceeds the threshold 46, the processor 30 is reset (restarted).

FIG. 10 is a flowchart illustrating an example of the short-circuit detection process executed by the detection unit. When power is supplied and the detection unit 40 starts up, the detection unit 40 executes the short-circuit detection process, for example.

The detection unit 40 first resets the integrator 43 in S10. The exemplary detection unit 40 resets the voltage of the integrator 43 to zero (0) V, which is the initial state. Next, the detection unit 40 subtracts a constant voltage (predetermined voltage) from the integrator 43 in S20. Although the process involves sequentially subtracting a constant amount, when the integrator 43 is configured as an analog integration circuit as illustrated in FIG. 9, the voltage decreases due to continuous discharge through a discharge resistor or similar means. The integrator 43 does not take negative values, and in the case of a zero voltage (0 V), it maintains 0 V even after the subtraction process.

Next, the detection unit 40 determines whether the output of the high-pass filter 41 exceeds the threshold (TH1) 45 in S30. If the output of the high-pass filter 41 exceeds the threshold 45, the detection unit 40 adds voltage to the integrator 43 in S40. In other words, the integrator 43 counts. As a result of the addition, the output voltage of the integrator 43 increases. Since the added voltage is larger than the subtracted voltage in S20, if a continuous affirmative (YES) determination is made in S30, the output voltage of the integrator 43 will continue to rise until it reaches the saturation voltage. If the output of the high-pass filter 41 is equal to or smaller than the threshold 45 in S30, the detection unit 40 skips the processing of S40 and proceeds to S50.

Next, the detection unit 40 determines whether the output of the integrator 43 exceeds the threshold (TH2) 46 in S50. If the output of the integrator 43 exceeds the threshold 46, the detection unit 40 enables the reset of the processor 30 in S60. In the exemplary detection unit 40, the comparator 44 activates the Reset signal, that is, outputs an L-level signal. As a result, the processor 30 is reset. If the output of the integrator 43 is below the threshold 46 in S50, the detection unit 40 executes the processing from S20 onward again.

After executing the processing in S60, the detection unit 40 determines whether the power supply of the detection unit 40 is off in S70. If the power supply is off, the short-circuit detection process is terminated. If the power supply is not off, the detection unit 40 executes the processing from S20 onward again. Alternatively, the processing in S70 may be omitted, and the short-circuit detection process may be terminated after executing the processing in S60.

### (Summary of First Embodiment)

The electronic control unit 10 according to the present embodiment includes the multi-phase power supply 22, the processor 30, and the detection unit 40. The detection unit 40 includes the comparator 42, the integrator 43, and the comparator 44. The comparator 42 compares the ripple component of the output voltage Vout of the multi-phase power supply 22 with the predetermined threshold 45. The integrator 43 counts the comparison results from the comparator 42. The comparator 44 compares the output of the integrator 43 with a threshold 46. The detection unit 40 outputs a predetermined signal when the output of the integrator 43 exceeds the threshold 46. In the exemplary electronic control unit 10, the processor 30 corresponds to the load. The comparator 42 corresponds to the first comparator, and the comparator 44 corresponds to the second comparator. The threshold 45 corresponds to the first threshold, and the threshold 46 corresponds to the second threshold.

By providing the detection unit 40 with the above configuration, it is possible to detect that the ripple component of the output voltage Vout is increasing continuously (steadily). Thus, it is possible to detect a short circuit occurring between different inductors 24 in the multi-phase power supply 22. For example, it is possible to distinguish and detect the continuous increase in the ripple component caused by a short circuit between inductors from the temporary increase in the ripple component due to load fluctuations.

The detection unit 40 may output a signal as a predetermined signal to reset the load (processor 30). Since the load operates by receiving the supply of the output voltage Vout, if a short circuit occurs between the inductors and the power supply becomes unstable, there is a possibility that the load may be abnormal. By resetting the load when the output of the integrator 43 exceeds the threshold 46, it is possible to prevent the abnormal operation of the load in advance.

The detection unit 40 may include the high-pass filter 41 that allows the ripple component to pass through. The comparator 42 may be configured to compare the ripple component that has passed through the high-pass filter 41 with the threshold 45. By using the high-pass filter 41, only the ripple component (AC component) of the output voltage Vout can be passed through. Therefore, the detection accuracy of the increase in the ripple component can be enhanced.

The threshold 46 may be set to a value greater than the output of the integrator 43 when the number of times the ripple component exceeds the threshold 45 is less than a predetermined number, and less than the output of the integrator 43 when the number of times the ripple component exceeds the threshold 45 is equal to or greater than the predetermined number. In this manner, by setting the detection count of the ripple component increase, it is possible to accurately distinguish between the increase in the ripple component due to load fluctuations and the increase in the ripple component due to an inter-inductor short.

The predetermined number of times may be set to a value greater than the number of times the ripple component exceeds the threshold 45 under the maximum fluctuation conditions of the load (processor 30). This prevents the increase in the ripple component due to load fluctuations from being mistakenly identified as an increase in the ripple component due to an inter-inductor short.

The multi-phase power supply 22 may include the coupled inductor 24C that includes multiple inductors 24 aligned in a predetermined direction and magnetically coupled to each other. By adopting the coupled inductor 24C with such a configuration, the effect of magnetic flux cancellation can be enhanced, thereby reducing the effective inductance. On the other hand, while adjacent inductors 24 may come closer together, making inter-inductor short circuit more likely due to foreign objects or other factors, the inclusion of the aforementioned detection unit 40 allows for the detection of such inter-inductor short circuit. The detection unit 40 is well-suited for a multi-phase power supply 22 that includes the coupled inductor 24C.

### Second Embodiment

This embodiment is a modified example based on the preceding embodiment, and the description of the preceding embodiment can be incorporated by reference. In addition to the preceding embodiment, the integrator may be reset at predetermined intervals.

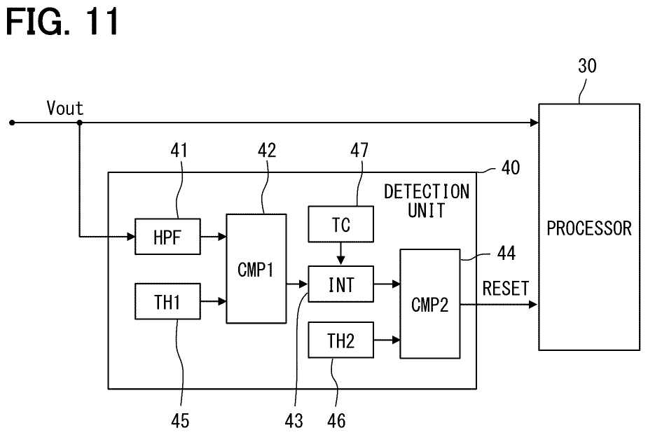

FIG. 11 is a block diagram illustrating an example of the detection unit in an electronic control unit according to this embodiment. The detection unit 40 shown in FIG. 11 further includes a timer counter (TC) 47 in addition to the configuration shown in the preceding embodiment (see FIG. 8). The timer counter 47 begins time measurement when the output of the comparator 42 switches to the H level. The timer counter 47 begins time measurement when the output of the H level from the comparator 42 begins. The timer counter 47 begins time measurement, for example, triggered by the first H level signal periodically output by the comparator 42 during an inter-inductor short circuit. The integrator 43 resets its count when the timer counter 47 has measured a predetermined period. In the exemplary integrator 43, the voltage is reset to zero (0) V. The predetermined period is indicated as the predetermined period PP in FIG. 9. The count of the timer counter 47 is reset in synchronization with the reset of the integrator 43, for example.

The threshold 46 is set to a value greater than the output voltage of the integrator 43 when the number of H-level signals output from the comparator 42 during the predetermined period is less than the predetermined number, and less than the output voltage of the integrator 43 when the number of H-level signals output from the comparator 42 during the predetermined period is equal to or greater than the predetermined number.

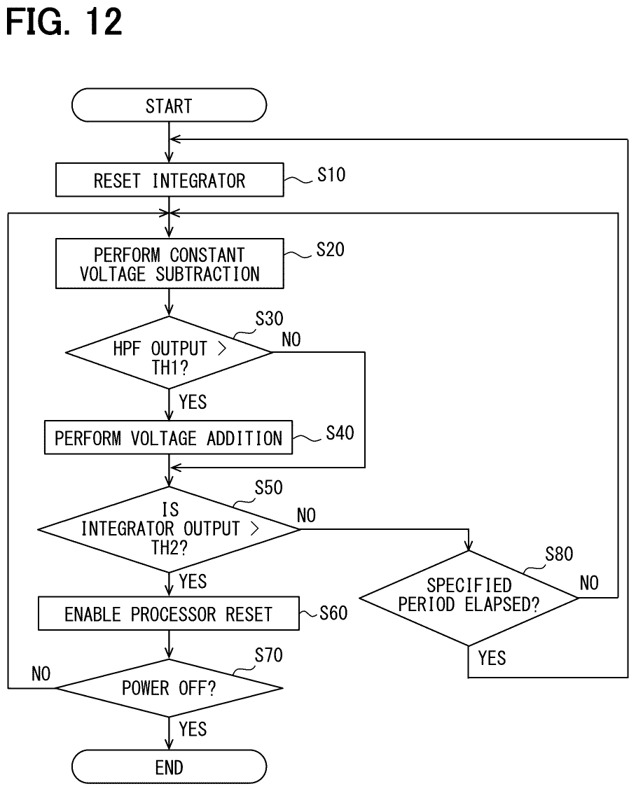

FIG. 12 is a flowchart illustrating an example of the process executed by the detection unit, specifically the short-circuit detection process. The process shown in FIG. 12 is obtained by adding S80 to the process described in the preceding embodiment (see FIG. 10).

If the result of the determination in S50 indicates that the output of the integrator 43 exceeds the threshold 46, the detection unit 40 executes the process in S60. If the output of the integrator 43 is smaller than or equal to the threshold 46, the detection unit 40 determines whether the predetermined period has elapsed in S80. If the predetermined period has not elapsed, the detection unit 40 executes the process again from S20 onward. If the predetermined period has elapsed, the detection unit 40 returns to S10 and resets the integrator 43. The other configurations are the same as those described in the prior embodiments. The process of S70 can be omitted, and the short-circuit detection process can be terminated after executing the process of S60.

### (Summary of Second Embodiment)

The threshold value 46 may be set to a value greater than the output of the integrator 43 when the number of times the ripple component exceeds the threshold value 45 within a predetermined period is less than a predetermined number, and to a value less than the output of the integrator 43 when the number of times the ripple component exceeds the threshold value 45 within the predetermined period is equal to or greater than the predetermined number. In this way, by setting the detection period in addition to the number of detections of the increase in the ripple component, it is possible to more accurately distinguish between the increase in the ripple component due to load fluctuations and the increase in the ripple component due to an inductor short.

The count of the integrator 43 may be reset if the number of times the ripple component exceeds the threshold value 45 by the end of the predetermined period is less than the predetermined number. In other words, the count of the integrator 43 may be reset if the output of the integrator 43 does not exceed the threshold value 46 during the predetermined period. This prevents misjudgment of the increase in the ripple component due to load fluctuations as an increase in the ripple component due to an inductor short when load fluctuations occur consecutively at relatively short intervals and the output of the integrator 43 rises.

### Other Embodiments

The present disclosure in the specification, the drawings and the like is not limited to the embodiments exemplified hereinabove. The disclosure encompasses the illustrated embodiments and modifications by those skilled in the art based thereon. For example, the disclosure is not limited to the combinations of components and/or elements shown in the embodiments. The disclosure may be implemented in various combinations. The present disclosure may have additional parts that may be added to the embodiments. The present disclosure encompasses modifications in which components and/or elements are omitted from the embodiments. The present disclosure encompasses the replacement or combination of components and/or elements between one embodiment and another. The technical scopes disclosed in the present disclosure are not limited to the description of the embodiments. The several technical scopes disclosed are indicated by the description of the present disclosure and should be further understood to include meanings equivalent to the description of the present disclosure and all modifications within the scope.

The disclosure in the description, the drawings, and the like is not limited by the description of the present disclosure. The disclosure in the specification, the drawings, and the like encompasses the technical ideas described in the present disclosure, and further extends to a wider variety of technical ideas than those in the present disclosure. Therefore, various technical ideas can be extracted from the disclosure of the description, the drawings, and the like without being restrained by the description of the present disclosure.

When an element or layer is mentioned to be “on”, “coupled”, “connected”, or “joined”, it may be directly on, coupled, connected, or joined to another element or another layer, and further an intervening element or an intervening layer may exist. In contrast, when an element is described as “directly disposed on,” “directly coupled to,” “directly connected to”, or “directly combined with” another element or another layer, there are no intervening elements or layers present. Other terms used to describe the relationships between elements (for example, “between” vs. “directly between”, and “adjacent” vs. “directly adjacent”) should be interpreted similarly. As used herein, the term “and/or” includes any combination and all combinations relating to one or more of the related listed items. For example, the term A and/or B includes only A, only B, or both A and B. In other words, the description “A and/or B” means at least one of A and B.

Spatially relative terms “inner”, “outer”, “back”, “below”, “low”, “above”, “high”, and the like are used herein to facilitate description of a relationship of one element or a feature to another element or feature as illustrated. Spatial relative terms can be intended to include different orientations of a device in use or operation, in addition to the orientations illustrated in the drawings. For example, when a device in a drawing is turned over, elements described as “below” or “directly below” other elements or features are oriented “above” the other elements or features. Therefore, the term “below” can include both above and below. The device may be oriented in another direction (rotated 90 degrees or in any other direction) and the spatially relative terms used herein are interpreted accordingly.

An example in which the power supply circuit 20 includes the primary power supply circuit 21 and the secondary power supply circuit 22 has been shown, but it is not limited to this example. An example in which the multiphase power supply 22 is included in a secondary power supply circuit has been shown, but it is not limited to this example.

What is claimed is:

1. An electronic control unit comprising:
a multiphase power supply including inductors;
a detector configured to detect a short circuit between the inductors based on an output voltage of the multiphase power supply; and
a load configured to operate with the output voltage of the multiphase power supply, wherein
the detector includes:
a first comparator configured to perform comparison between a ripple component of the output voltage and a predetermined first threshold;
an integrator configured to perform counting of a result of the comparison performed by the first comparator; and
a second comparator configured to perform comparison between an output of the integrator and a predetermined second threshold, and
the detector is configured to output a predetermined signal, on a condition that the output of the integrator exceeds the predetermined second threshold.

2. The electronic control unit according to claim 1, wherein
the predetermined signal output from the detector is a signal that resets the load.

3. The electronic control unit according to claim 1, wherein
the detector includes a high-pass filter configured to allow the ripple component of the output voltage to pass through the high-pass filter, and
the first comparator is configured to perform comparison between the first predetermined first threshold and the ripple component that has passed through the high-pass filter.

4. The electronic control unit according to claim 1, wherein
the predetermined second threshold is set
to be larger than the output of the integrator on a condition that number of times the ripple component exceeds the predetermined first threshold is smaller than a predetermined number of times, and
to be smaller than the output of the integrator on a condition that the number of times the ripple component exceeds the predetermined first threshold is larger than or equal to the predetermined number of times.

5. The electronic control unit according to claim 4, wherein
the predetermined second threshold is set
to be larger than the output of the integrator on a condition that the number of times the ripple component exceeds the predetermined first threshold within a predetermined period is smaller than the predetermined number of times, and
to be smaller than the output of the integrator on a condition that the number of times the ripple component exceeds the predetermined first threshold within the predetermined period is larger than or equal to the predetermined number of times.

6. The electronic control unit according to claim 5, wherein
a result of the counting performed by the integrator is reset, on a condition that the number of times the ripple component exceeds the predetermined first threshold is smaller than the predetermined number of times at an end of the predetermined period.

7. The electronic control unit according to claim 4, wherein
the predetermined number of times is set to be larger than the number of times the ripple component exceeds the predetermined first threshold under a maximum variation condition of the load.

8. The electronic control unit according to claim 1, wherein
the multiphase power supply includes a coupled inductor having the inductors, and
the inductors included in the coupled inductor are aligned in a predetermined direction and are mutually magnetically coupled.
